(19) United States
(12) Patent Application Publication
(10) Pub. No.: US 2023/0237855 A1
(43) Pub. Date: Jul. 27, 2023

(54) OPTIMIZING FLEET BATTERY PACK CHARGING BASED ON SCHEDULE DATA

(71) Applicant: Wireless Advanced Vehicle Electrification, LLC, Salt Lake City, UT (US)

(72) Inventors: Michael MASQUELIER, Park City, UT (US); Steven BALL, Sandy, UT (US); Arash RASTEH, Herriman, UT (US)

(21) Appl. No.: 17/583,043

(22) Filed: Jan. 24, 2022

(51) Int. Cl. G07C 5/00; B60L 58/16; B60L 58/12; G07C 5/02

(52) U.S. Cl. CPC G07C 5/008; B60L 58/16; B60L 58/12; G07C 5/02; B60L 53/80

(57) ABSTRACT

Described herein are techniques for optimizing charging and/or replacement of battery packs within a fleet of electric vehicles. In some embodiments, such techniques may include receiving information indicating a current status of one or more electric vehicles in a fleet of electric vehicles, identifying schedule data for the one or more electric vehicles, and determining, based on the schedule data and the current status of the one or more vehicles, a charging schedule for the fleet of electric vehicles. The techniques may further include correlating one or more charging plates to the one or more electric vehicles and directing power to the one or more charging plates in accordance with the determined charging schedule.

### BACKGROUND

As the world becomes more aware of the impact that the use of fossil fuels is having on the environment, the demand for environmentally friendly alternatives is increasing. In the realm of transportation, vehicles that are powered by fossil fuels are being replaced by electric vehicles. In some cases, entire fleets of transit vehicles, such as busses, are being replaced by electric vehicles. However, despite this increase in popularity, electric vehicles are subject to their own unique set of problems. For example, the range of an electric vehicle is often dependent upon the amount of charge that can be, or is, stored in a battery of that vehicle. However, the capacity of such a battery may change over time, with the battery capable of storing less charge as it is charged or ages. In a fleet of electric vehicles, uneven wear of battery packs can require costly maintenance actions.

### SUMMARY

Techniques are provided herein for optimizing charging and/or distribution of electric vehicle battery packs based on schedule data. In embodiments as described herein, distribution and/or charging of electric vehicle fleet battery packs is performed in a manner that ensures each vehicle has a sufficient charge to complete an assigned transit route while minimizing charging costs for the fleet. In some embodiments, battery pack distribution is managed in a manner such that wear on the battery packs associated with a fleet is evenly distributed. In some embodiments, charging of electric vehicle fleet battery packs is performed within specified conditions (e.g., staying under a load capacity of a circuit on which recharging plates are included).

In one embodiment, a method is disclosed as being performed by a computing device that manages fleet operations, such as a fleet management platform, the method comprising receiving information indicating a current status of one or more electric vehicles in a fleet of electric vehicles, identifying schedule data for the one or more electric vehicles, determining, based on the schedule data and the current status of the one or more vehicles, a charging schedule for the fleet of electric vehicles, correlating one or more charging plates to the one or more electric vehicles, and directing power to the one or more charging plates in accordance with the determined charging schedule.

An embodiment is directed to a computing device comprising a processor; and a memory including instructions that, when executed with the processor, cause the computing device to, at least receive information indicating a current status of one or more electric vehicles in a fleet of electric vehicles, identify schedule data for the one or more electric vehicles, determine, based on the schedule data and the current status of the one or more vehicles, a charging schedule for the fleet of electric vehicles, correlate one or more charging plates to the one or more electric vehicles, and direct power to the one or more charging plates in accordance with the determined charging schedule.

An embodiment is directed to a non-transitory computer-readable media collectively storing computer-executable instructions that upon execution cause one or more computing devices to collectively perform acts comprising receiving information indicating a current status of one or more electric vehicles in a fleet of electric vehicles, identifying schedule data for the one or more electric vehicles, determining, based on the schedule data and the current status of the one or more vehicles, a charging schedule for the fleet of electric vehicles, correlating one or more charging plates to the one or more electric vehicles, and directing power to the one or more charging plates in accordance with the determined charging schedule.

Embodiments of the disclosure provide numerous advantages over conventional systems. For example, the system disclosed herein enables efficient optimization of fleet vehicle charging in a manner that minimizes costs. Additionally, embodiments of the current disclosure enable operators of a fleet of electric vehicles to distribute battery packs among vehicles in a manner that results in a more even spread of wear across those battery packs while ensuring that electric vehicles can complete their assigned transit routes. This can result in optimizing the life of battery packs used by the fleet.

The foregoing, together with other features and embodiments will become more apparent upon referring to the following specification, claims, and accompanying drawings.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a computing environment in which battery pack distribution and/or charging may be managed based on schedule data in accordance with embodiments;

FIG. 2 illustrates a block diagram showing various components of an example system architecture that supports optimized charging/distribution of electric vehicle battery packs in accordance with some embodiments;

FIG. 3 illustrates a flow chart of an example process by which charging, and assignment, of battery packs can be optimized in accordance with at least some embodiments;

FIG. 4 depicts an example vehicle charging environment that may be implemented to optimize charging of a fleet of electrical vehicles in accordance with at least some embodiments;

FIG. 5 depicts a flow diagram showing an example process flow for generating a charging schedule and routing power to one or more charging plates in accordance with embodiments; and

FIG. 6 depicts a flow diagram showing an example process flow for distributing battery packs throughout a fleet in accordance with embodiments.

### DETAILED DESCRIPTION

This disclosure is directed towards a system that enables optimization of fleet vehicle/battery pack distribution and charging based on schedule data. In embodiments, a determined current status of vehicles and/or battery packs is used, along with schedule data for the fleet of electric vehicles, to generate a charging schedule. Such a charging schedule is generated to ensure that each of the vehicles in the fleet of vehicles is able to complete its respective assigned transit route. In some embodiments, a number of charging plates may be correlated to particular electric vehicles by virtue of being proximate to those vehicles. Power may then be directed to one or more of the charging plates in accordance with the charging schedule. In some embodiments, battery packs may also be swapped out between vehicles in accordance with the charging schedule and/or to manage wear on battery packs.

In embodiments, information indicating a current status of one or more battery packs installed within electric vehicles of a fleet may be received. In some cases, the information may be received from one or more components included within the vehicles themselves. In some cases, the information may be received from a charging plate in communication with an electric vehicle. For example, the charging plate may communicate (either wirelessly or via a wired connection) with one or more sensors coupled to the battery pack. Such data may indicate a current level of charge of the battery pack as well as a maximum capacity of the battery pack that may be used to determine a level of wear.

Schedule data may be maintained for each transit route to be completed and/or each vehicle in the fleet of electric vehicles. In some embodiments, vehicles may be assigned to a transit route ahead of time. In other embodiments, vehicles may be assigned to a transit route dynamically (e.g., as a determination is made regarding a vehicle's ability to complete the transit route). The schedule data may indicate any of start and/or end times for each transit route, charging stations located along the transit route, a number of stops/traffic hinderances along the route, a distance (e.g., distance of the route and/or distance between stops), or any other suitable information that pertains to operation of a vehicle with respect to time. In some embodiments, the schedule data may indicate a number of stops along a transit route as well as a time at which an assigned vehicle is to reach/leave those stops.

Based on the current status information for each of the electric vehicles as well as the schedule data, a charging schedule may be generated. Such a charging schedule may indicate an order in which the vehicles are to be charged. In some embodiments, a charging schedule may indicate to which charging plates power is to be directed, a period of time over which that power is to be provided, an amount of power to be provided, etc. In some embodiments, a charging time may be calculated for each vehicle based on its current status as well as a minimum sufficient charge needed to complete a respective transit route. Each vehicle may then be scheduled for charging based on its determined respective charging time in a manner such that each vehicle is to be charged before beginning its respective route. In the case that it is not possible to sufficiently charge a vehicle before it is scheduled to begin its respective transit route, a different vehicle may be assigned to the transit route or instructions may be provided to swap out a battery pack of the vehicle with another battery pack that has a higher amount of charge. In some embodiments, the charging schedule may be generated such that the total amount of power used in charging does not surpass a predetermined threshold load capacity. In some cases, such a threshold load capacity may change dynamically (e.g., based on current power costs, etc.).

Once a charging schedule has been generated in the above manner, that charging schedule may be executed to charge the fleet of vehicles. In some embodiments, electric vehicles may be correlated to charging plates based on their proximity. For example, each charging plate may identify a vehicle within its proximity to be charged by that charging plate. In this example, the vehicle may wirelessly transmit a vehicle or battery pack identifier to the charging plate via a short-range wireless transmission means (e.g., Radio Frequency Identifier (RFID) tags, etc.). Upon execution of a charging schedule, a fleet management platform may direct power to various charging plates in accordance with the charging schedule.

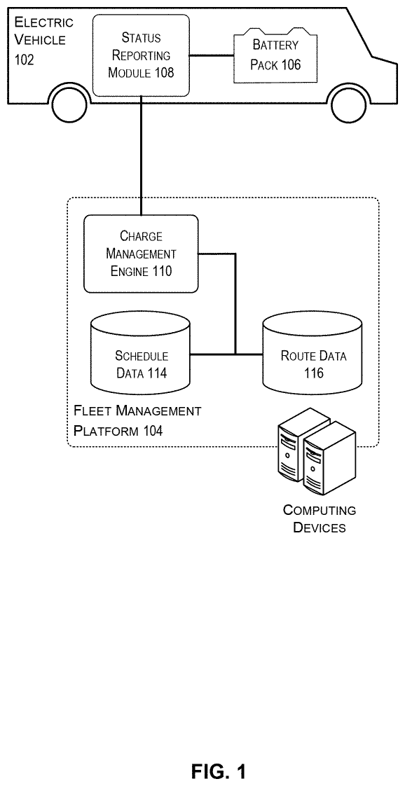

FIG. 1 illustrates a computing environment in which battery pack distribution and/or charging may be managed based on schedule data in accordance with embodiments. In some embodiments, one or more electric vehicle 102 is in communication with a fleet management platform 104. In some embodiments, the electric vehicle is in continuous or semi-continuous communication with the fleet management platform via a wireless communication channel. In some embodiments, the electric vehicle may establish communication with the fleet management platform upon arriving at particular access points (e.g., recharging stations and/or bus stops).

An electric vehicle 102 may include any suitable mode of transportation that operates primarily using electric current. In some embodiments, electric current available to a particular electric vehicle may be limited based on a capacity of a battery pack or other electric storage medium. In some embodiments, the charge on a battery pack of the electric vehicle may be restored at least partially throughout a vehicle's operation. For example, in the case that the electric vehicle is a bus that makes stops along a route, the battery pack of the electric vehicle may be recharged at least partially each time that the bus positions itself over a charging pad located at one of the bus stops. In another example, the electric vehicle may be configured to perform regenerative braking each time that the vehicle slows down or stops, which is an energy recovery mechanism that slows down a moving vehicle or object by converting its kinetic energy into a form that can be either used immediately or stored until needed (in this case, battery charge).

Additionally, the electric vehicle may include a battery pack 106 that is configured to power the electric vehicle. One or more sensors installed in the electric vehicle may be in communication with the battery pack to obtain information about a status of the battery pack. For example, the one or more sensors in communication with the battery pack may obtain information about a current charge of the battery pack, a rate at which the battery pack is being charged/discharged, a maximum battery capacity, or any or any other suitable information. Herein the description distinguishes between a battery pack, which may include multiple batteries and a battery, which may include multiple ‘cells’ each capable of storing electrical charge. Management of batteries and battery packs may be conducted independently, for example, a battery pack of six (6) batteries may be swapped out for maintenance purposes even though only one of the batteries in the pack requires replacement, reconditioning and/or recycling. In particular, identifiers and/or performance statistics may be associated with particular battery packs instead of and/or in addition to identifiers and/or performance statistics that are associated with individual batteries and/or battery cells. Measures of wear for a battery pack may be determined (e.g., measured) separately from measures of wear for individual batteries.

Data obtained from one or more sensors in communication with the battery pack may be provided to a status reporting module 108 executed within a memory of the electric vehicle. The status reporting module may be configured to report a status of the electric vehicle (including a status of the battery pack) to the fleet management platform. In some cases, the status reporting module may report data on a continuous basis (e.g., at predetermined intervals). In some cases, the status reporting module may report data to the fleet management platform at particular times. For example, the status reporting module may report data to the fleet management platform upon entering a charging/base facility.

The fleet management platform 104 may include any computing device or combination of computing devices configured to perform at least a portion of the functionality described herein. Fleet management platform may be composed of one or more general purpose computers, specialized server computers (including, by way of example, PC (personal computer) servers, UNIX™ servers, mid-range servers, mainframe computers, rack-mounted servers, etc.), server farms, server clusters, or any other appropriate arrangement and/or combination. Fleet management platform can include one or more virtual machines running virtual operating systems, or other computing architectures involving virtualization such as one or more flexible pools of logical storage devices that can be virtualized to maintain virtual storage devices for the computer.

The fleet management platform 104 may include one or more software modules configured to optimize electric vehicle charging activities for a fleet within given constraints, such as charge management engine 110. For example, a transit station, or charging facility, may be limited to a specified load capacity for that transit station. In this example, a sum of load capacities for each of a number of individual charging stations may be prevented from exceeding the specified load capacity. In some cases, the specified load capacity for the transit station may be determined based on one or more factors. By way of non-limiting example, such factors may include a time of day, a current cost of electricity, a demand or urgency associated with charging activities, or any other suitable factor.

In some embodiments, the fleet management platform may be configured to maintain schedule data 114 that includes an indication of time periods during which one or vehicles is scheduled to be assigned to a transit route, as well as route data 116 that includes information about locations included along a transit route. The information included within either the schedule data 114 and/or the route data 116 may be used during an optimization process. For example, one or more charging operations may be assigned or scheduled based on such data.

Within a fleet management platform, a charge management engine 110 may be configured to optimize distribution of battery packs among vehicles and/or transit routes based on schedule data. In some cases, battery packs may be swapped out between vehicles in order to ensure that wear resulting from use is distributed evenly amongst the battery packs for a fleet. In some cases, a fleet may have associated with it a number of battery packs that are in-use (e.g., currently installed within electric vehicles) as well as a number of battery packs that are stored (e.g., in a warehouse). Battery packs that are stored may be separated into those that are stored in a ready-to-deploy state and those that are stored in a maintenance state. In embodiments, the fleet management platform may maintain a mapping of battery packs (as identified via a battery pack identifiers) to current levels of wear. In some cases, a current level of wear may be determined for a battery pack based on a total load capacity for each respective battery pack. In these cases, a total load capacity may be determined for a battery pack by monitoring a change in voltage for that battery pack as the battery pack is charged or discharged.

The charge management engine may be configured to generate a battery pack distribution schedule that ensures even wear on battery packs that are associated with the fleet of vehicles. In some embodiments, this comprises identifying the battery packs having the greatest amount of current wear, or those assigned to transit routes that generate the greatest amount of wear, and assign those battery packs to positions that will impose the least amount of wear. In some embodiments, each battery pack associated with a fleet of battery packs may be assigned a ranking that corresponds to its current level of wear. In such embodiments, each potential position into which a battery pack is to be placed may be assigned a separate ranking that corresponds to an amount of wear that is generated by that position. For example, where vehicles are assigned to transit routes, each of those transit routes may be assigned a ranking that corresponds to an amount of wear that is generated via that transit route. In some embodiments, a number of attributes associated with a transit route may be used to calculate an amount of wear for that route. For example, the distance of the route, the number of recharging stations or transit stops along the route, the number of stoplights or other traffic stops along the route, a degree of uphill incline along the route, or any other suitable factor may be used to calculate an amount of wear to be associated with the route in order to generate a ranking. In some embodiments, an amount of wear may be determined by testing one or more battery packs before and after the route. Once battery packs have been ranked on a current level of wear and positions (e.g., transit routes) have been ranked on an amount of wear contributed by that position, battery packs may be assigned to positions in an inverse order. For example, the battery packs having the highest current level of wear may be assigned to the positions that contribute the lowest amount of wear. In some embodiments, rather than require a swap out of battery packs within a vehicle, the vehicles housing each respective battery pack may be assigned to a position. For example, upon determining which transit routes each battery pack is to be assigned to, the vehicles currently housing those battery packs may be assigned to the respective transit routes.

Additionally, fleet charging activities may be optimized via the charge management engine 110 that is configured to schedule charging activities pertaining to a number of electric vehicles and/or charging plates. In some embodiments, the charge management engine 110 may be configured to direct power to specified charging plates within a charging facility during charging operations. The charge management engine may direct power to charging plates in a manner that allows for optimization of vehicle charging while maintaining, or at least not exceeding, a specified load capacity. In some embodiments, one or more vehicles may enter a charging facility and may be positioned over charging plates within that facility. In these embodiments, power is directed to a charging plate in order to wirelessly replenish a battery pack of the electric vehicle positioned over that charging plate. The charge management engine may be configured to determine times and durations for which power is to be directed to specified charging plates in order to ensure that each vehicle is sufficiently charged for its respective transit route while minimizing costs associated with the charging process.

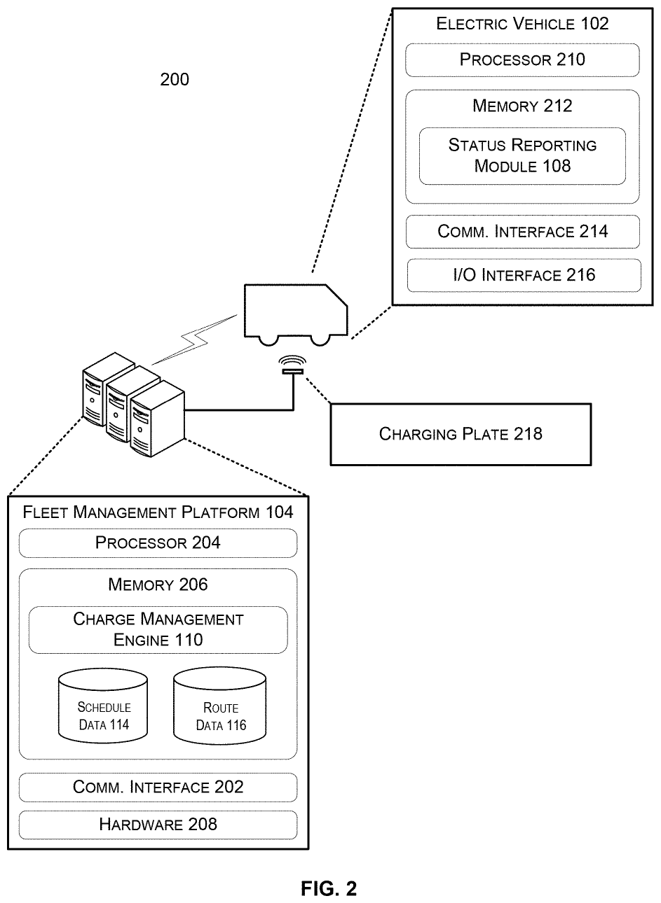

FIG. 2 illustrates a block diagram showing various components of a system architecture that supports optimized charging/distribution of electric vehicle battery packs in accordance with some embodiments. The system architecture may include a fleet management platform 104 in communication with one or more electric vehicles 102.

As noted above, a fleet management platform 104 can include any computing device configured to perform at least a portion of the operations described herein. The fleet management platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The fleet management platform 104 can include one or more virtual machines running virtual operating systems, or other computing architectures involving virtualization such as one or more flexible pools of logical storage devices that can be virtualized to maintain virtual storage devices for the computer. For example, the fleet management platform 104 may include virtual computing devices in the form of virtual machines or software containers that are hosted in a cloud.

The fleet management platform 104 may include a communication interface 202, one or more processors 204, memory 206, and hardware 208. The communication interface 202 may include wireless and/or wired communication components that enable the fleet management platform 104 to transmit data to, and receive data from, other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the fleet management platform 104 may implement functionality that includes one or more software modules and data stores. Such software modules may include routines, program instructions, objects, and/or data structures that are executed by the processors 204 to perform particular tasks or implement particular data types. More particularly, the memory 206 may include at least a module that is configured to manage charging operations in relation to one or more vehicles in a fleet of electric vehicles. Additionally, the fleet management platform may include a number of data stores that include information that may be used by the fleet management platform to optimize charging operations of the fleet. For example, the fleet management platform may include a database of information on transit route schedules (e.g., schedule data 114) and/or a database of information on geographical locations included in a transit route (e.g., route data 116).

A charge management engine 110 may be configured to, in conjunction with the processor 204, perform optimization of battery pack distribution and charging operations. In some embodiments, this may comprise determining a schedule (i.e., an ordered series of charging operations) for distributing and/or charging a number of battery packs withing vehicles. In some embodiments, such a schedule may be generated based on information about transit routes assigned to the number of vehicles and schedule data stored in relation to those respective transit routes.

It should be noted that, in general, a maximum charge holdable by a battery pack tends to decrease with the age of that battery pack (e.g., as wear increases). In some embodiments, the charge management engine is configured to determine a battery replacement strategy based on a current status of a vehicle battery pack. For example, in some cases, a determination may be made as to a maximum range of an electric vehicle using a particular battery pack. In this example, battery packs may be swapped out between vehicles in order to ensure that each of the vehicles is able to complete its respective assigned route.

In some embodiments, the charge management engine may maintain information about an amount or degree of wear or strain that is placed on a battery pack in relation to one or more transit routes. In these embodiments, battery packs may be distributed to electric vehicles in a manner that evenly distributes wear to those battery packs. For example, a battery pack currently having the least amount of wear may be installed within an electric vehicle assigned to a transit route that places the greatest amount of wear on the battery pack. In some embodiments, battery packs may be switched between vehicles based on a likelihood of each vehicle being able to complete its respective transit route determined based on a maximum available charge at the time of that the route is to be traversed and a distance that may be traveled using that maximum available charge. Such a maximum available charge may, in turn, be determined based on a current amount of charge on the battery pack as well as a maximum amount of additional charge that may be placed on the battery pack before the assigned transit route is scheduled to begin.

By way of example, if an electric bus enters a transit station upon completion of a first transit route, the charge management engine may determine that the electric bus is scheduled to begin a second transit route within 8 minutes. A minimum battery pack charge may then be obtained in relation to the second transit route (i.e., an amount of charge required to travel the distance of the transit route). A determination may then be made that, based on the current charge of the battery pack in the electric vehicle and an available rate of charge, it is not possible to charge the battery pack to the minimum battery pack charge within 8 minutes. Accordingly, instructions may be generated to switch out the battery pack with one that either has sufficient charge or one that can reach sufficient charge within the allotted time.

A noted elsewhere, an electric vehicle 102 may comprise any suitable vehicle that is primarily powered using electrical current. In addition to including various components required to enable transit, the electric vehicle includes one or more processors 210, a memory 212, a communication interface 214, and an input/output interface 216.

The one or more processors 210 and the memory 212 of the fleet management platform 104 may implement functionality that includes one or more software modules and data stores. Such software modules may include routines, program instructions, objects, and/or data structures that are executed by the processors 210 to execute one or more functions of the electric vehicle. More particularly, the memory 212 may include at least a module that is configured to facilitate the reporting of vehicle status data (e.g., status reporting module 108) and a module for determining an identity of a current driver of the electric vehicle to be associated with the identified driving behavior.

A status reporting module 108 may be configured to, in conjunction with the processor 210, determine a current status of the electric vehicle and to report that status to a fleet management platform. The status reporting module may determine a current status of a battery pack installed within the electric vehicle. Such a status may indicate a current charge of the battery pack and/or a predicted capacity of the battery pack. In some cases, one or more sensors may monitor a discharge of the battery pack throughout operation of the electric vehicle. For example, sensors may monitor a voltage and a number of amps generated by the battery pack. In some cases, an age or an amount of wear on the battery pack may be determined based on a rate of change in data collected during the battery pack discharge (e.g., throughout operation).

In some embodiments, the fleet management platform may be in communication with at least one charging plate 218. A charging plate may be any device or mechanism capable of providing wireless transmission of power to a charging receiver of an electrical vehicle located in proximity of the charging plate. In some embodiments, the charging plate may be configured to communicate with an electric vehicle in its proximity (e.g., to receive a vehicle identifier, etc.).

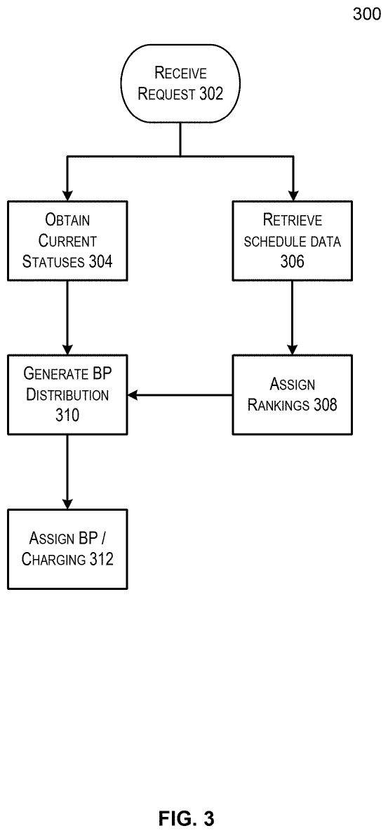

FIG. 3 illustrates a flow chart process by which charging, and assignment, of battery packs can be optimized in accordance with at least some embodiments. The process 300 involves a number of interactions between various components of the computing environment described with respect to FIG. 1.

At 302, the process 300 comprises receiving a request to optimize battery pack allocation/charging in accordance with embodiments. In some embodiments, such a request may be received automatically when a vehicle enters a predetermined space (e.g., a base charging station). For example, when an electric bus enters a charging facility between transit routes, a request may be submitted to assess whether the battery pack needs to be reallocated/replaced. In some embodiments, a request is received automatically when predetermined conditions have been met. For example, such a request may be received automatically once a predetermined time has been reached or once all outstanding transit routes have been completed for the day.

At 304, the process 300 comprises obtaining current status data from one or more of the electric vehicles. In some embodiments, the status data may be received via a communication session established between the fleet management platform and the electric vehicle. In some embodiments, the status data may indicate a current charge of a battery pack installed within an electric vehicle. In some cases, the status data may further indicate a condition (e.g., age, maximum capacity, discharge rate, etc.) of the battery pack.

At 306, the fleet management platform may retrieve schedule data pertaining to the fleet of electric vehicles. Such schedule data may indicate assignments of an electric vehicles to transit routes and timing for such. For example, the schedule data may indicate a transit route as well as one or more periods of time during which an electric vehicle is to be operated on that route. The schedule data may be used to determine what time particular electric vehicles are to be used as well as a distance over which they will be used.

At 308, the fleet management platform may assign rankings to each of a number of battery packs/vehicles and/or a number of positions (e.g., transit routes). The fleet management platform may rank each electric vehicle based on battery pack/charging needs related to its scheduled transit route. More particularly, a determination may be made, for each electric vehicle, as to an amount of charging time needed to reach a minimum sufficient charge for the respective transit route. This determination may be made based at least in part on a current level of charge of the battery pack as well as a rate at which the battery pack can be charged. The vehicles' respective rankings may then be used to generate a charging schedule as described below.

In some embodiments, each battery pack associated with a fleet of battery packs may be assigned a ranking that corresponds to its current level of wear. In such embodiments, each potential position into which a battery pack is to be placed may be assigned a separate ranking that corresponds to an amount of wear that is generated by that position. For example, where vehicles are assigned to transit routes, each of those transit routes may be assigned a ranking that corresponds to an amount of wear that is generated via that transit route.

In some embodiments, the determined amount of time needed to reach the sufficient minimum charge may be compared to an amount of time before a respective transit route is scheduled to begin. If the amount of time needed to reach the sufficient minimum charge is greater than the amount of time before the respective transit route is scheduled to begin, then a determination may be made that it is not possible to reach the sufficient minimum charge with the currently installed battery pack.

At 310, the process 300 comprises generating a battery pack distribution strategy. In some embodiments, this may comprise identifying each of the vehicles that currently have battery packs that need to be swapped to distribute wear as well as vehicles/battery packs that cannot be charged to a degree that their respective sufficient minimum charge can be obtained. Other vehicles may then be identified as having battery packs that have a current charge that is sufficient to obtain the respective sufficient minimum charge for one of the vehicles that cannot obtain sufficient charge. Provided that both battery packs have sufficient current charge to reach a respective sufficient minimum charge for their transit routes, the battery packs may be swapped. In some embodiments, battery packs may be swapped to even out wear on those battery packs. For example, a battery pack installed within a vehicle assigned to a route that is hard on battery packs may be swapped out with a battery pack installed within a vehicle assigned to a route that is not as hard on battery packs after some predetermined amount of time.

At 312, the process 300 comprises assigning charging of battery packs. In some embodiments, power is directed to charging plates in proximity of each of the battery packs (e.g., within an electric vehicle) to be charged during specified periods of time in accordance with a charging schedule. As noted elsewhere, only a portion of the total number of charging plates may be powered during certain times in order to minimize costs. In other words, charging may be performed in a manner such that a maximum load does not exceed a threshold load capacity. In some cases, the threshold load capacity may be dynamically determined based on a current cost of power.

In some embodiments, a charging schedule may be generated by assigning to each battery pack/electric vehicle periods of time over which it is to be charged. In some cases, the amount, or rate, of power to be provided during those periods of time may also be determined. In some embodiments, the charging schedule may be generated based on rankings assigned to one or more battery packs/electric vehicles. For example, in such a charging schedule, higher rankings may be scheduled to occur before lower rankings.

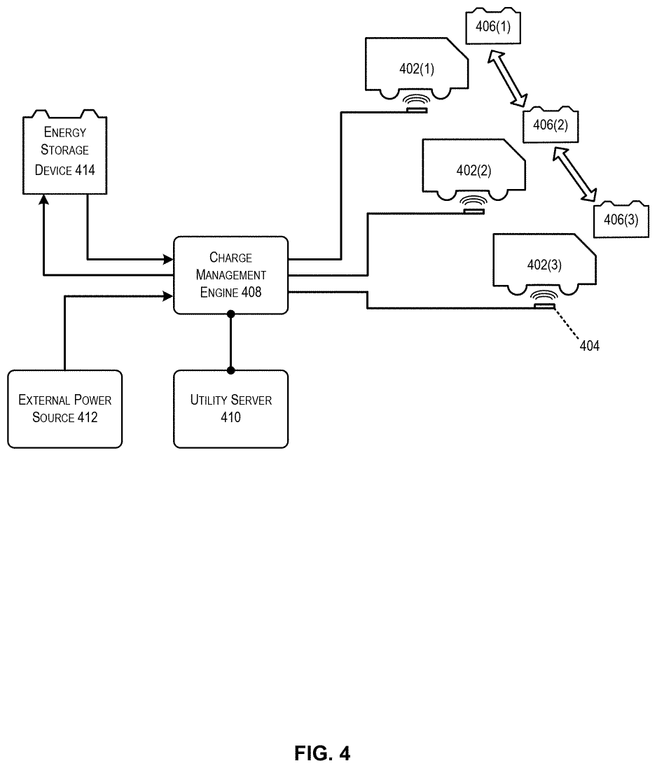

FIG. 4 depicts a vehicle charging environment that may be implemented to optimize distribution and charging of battery packs for a fleet of electrical vehicles in accordance with at least some embodiments. In some embodiments, the environment 400 depicted in FIG. 4 may be implemented within a vehicle charging facility (e.g., a transportation hub), such as a facility at which one or more electric vehicles is stored overnight.

Each of a number of electric vehicles 402 (e.g., electric vehicles 402 (1-3)) may be positioned over a respective charging plate 404. In some embodiments, each charging plate may be configured to provide power to an electric vehicle positioned in proximity to the electric vehicle. Such power may be provided by the charging plate to the electric vehicle via either wired or wireless means. In some embodiments, the charging plate may receive information from the electric vehicle (and/or a battery pack installed within the vehicle), such as an identifier and/or status information, which may be relayed to another computing device.

Each of the electric vehicles may include at least one battery pack 406 (e.g., battery packs 406 (1-3)). The battery packs may be configured to be removed and/or replaced within the electric vehicle. For example, each electric vehicle may include a receptacle into which a battery pack may be placed and hooked up.

Power may be distributed to each of a number of charging plates by a charge management engine 408. In some embodiments, the charge management engine may receive (either from a charging plate or from an electric vehicle) an indication of which electric vehicle is positioned at which charging plate.

In some embodiments, the charge management engine may be configured to determine an allocation and/or schedule for charging the battery packs included within the number of electric vehicles. Based on such a schedule, the charge management engine may be configured to direct power to particular charging plates located throughout a facility. In some embodiments, the charge management engine may be configured to control the amount of power that is directed to one or more of the charging plates. In some embodiments, the schedule may be generated in a manner that allows for a sufficient amount of charging of each electric vehicle in order to complete a respective transit route. For example, the charge management engine may determine a minimum sufficient charge needed to complete each route, a time at which each transit route is to be started, as well as a current charge on a battery pack included within each of a number of electric vehicles. In this example, the charge management engine then determines, based on the current charge for each vehicle battery pack, an amount of charging time needed by each vehicle to reach its respective minimum sufficient charge. That amount of charging time is then used to determine whether it is possible to obtain the minimum sufficient charge by the time that the transit route is scheduled to begin. If a determination is made that a sufficient charge cannot be obtained by such a time, then the charge management engine may consider battery packs that have a higher amount of charge that can be swapped out with the battery pack in the vehicle that will not obtain a sufficient charge.

In some embodiments, the charge management engine may be configured to optimize battery pack swapping and/or charging within specified constraints. For example, the charge management engine may be configured to keep the total amount of power directed toward charging below a predetermined threshold power load value. In this example, it may not be possible to direct power to charge every electric vehicle. Accordingly, the charge management engine may be configured to generate a charging schedule for the vehicles that need to be charged. In such a schedule, each vehicle may be assigned one or more periods of time over which the vehicle is to be charged as well as an amount of power to be provided to a charging plate in proximity to that vehicle during the one or more periods of time. In such a schedule, the vehicles may be charged in a manner that enables each of the vehicles to achieve a minimum sufficient charge by the time that the vehicle is scheduled to begin its transit route.

In some embodiments, the charge management engine may be further configured to provide remote power for startup operations of one or more electric vehicles. For example, a predetermined amount of time before a vehicle is scheduled to begin its first transit route of the day, the vehicle may be started up and a heater/air conditioner may be initiated to obtain an optimal interior temperature. In this example, the charging engine may be configured to provide power to a charging plate in the proximity of the respective vehicle in order to power such startup operations so that they do not drain the battery pack of the vehicle. In this example, power provided in this manner may be accounted for by the charge management engine when generating a schedule.

In some embodiments, the charge management engine may be in communication with one or more external computing devices from which it receives information. For example, the charge management engine may be in communication with a utility server 410 from which it receives current power cost data. In some embodiments, the charge management engine may be configured to make optimization decisions based on the information received from one or more external computing devices. For example, the charge management engine may be configured to provide charging to electric vehicles while keeping the total cost under a predetermined cost threshold value.

In the depicted vehicle charging environment, the charge management engine may be in communication with an energy grid that supplies power to one or more charging plates. Such an energy grid may draw power from at least one external power source 412. In some embodiments, the energy grid of the environment may include at least one energy storage device 414. Grid-level energy storage can reduce supply and demand mismatch by shifting energy from times of low demand to high demand, or from times when external power is cheap to when it is expensive. Additionally, energy storage can be charged or discharged rapidly, which can reduce the dependency on fast (e.g., high current) external power sources. In some embodiments, such an energy storage device can provide power quality, load shifting, load leveling, energy management, frequency regulation, backup power, voltage support, and/or grid stabilization.

In some embodiments, the charge management engine in communication with at least one energy storage device can take advantage of market operations and optimize energy costs using energy arbitrage. By exploiting the difference in market prices, a charge management engine in communication with an energy storage device may purchase power when the price is low, store this energy, and use the energy when energy costs are high (in lieu of purchasing power at the high cost), thereby reducing the overall cost of energy for the fleet of electric vehicles.

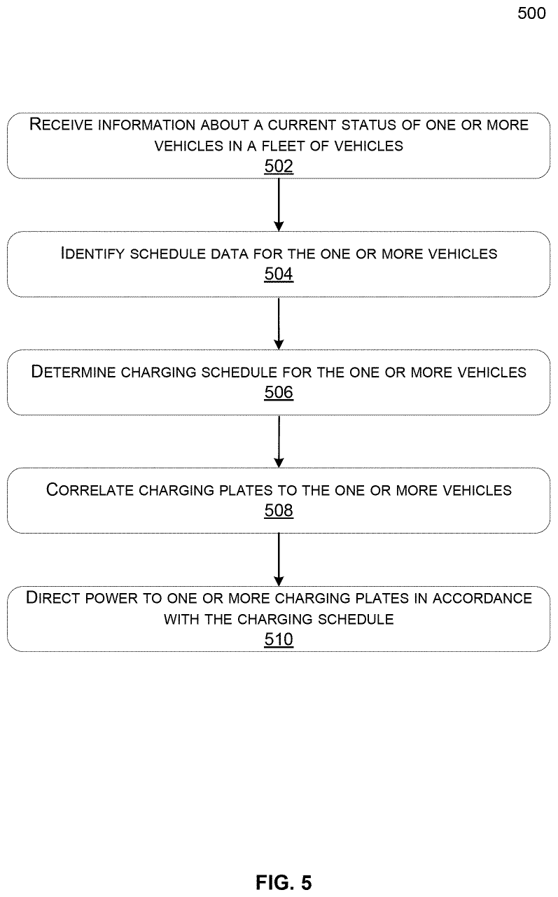

FIG. 5 depicts a flow diagram showing an example process flow 500 for generating a charging schedule and routing power to one or more charging plates in accordance with embodiments. The process 500 may be performed by a computing device that is configured to generate and provide a product strategy for a product. For example, the process 500 may be performed by a computing device configured to manage at least a portion of fleet operations, such as the fleet management platform 104 described with respect to FIG. 1 above.

At 502, the process 500 comprises receiving information about a current status of one or more vehicles in a fleet of electric vehicles. In some embodiments, the current status comprises an indication of a current battery pack charge level for the electric vehicle. In some embodiments, the information indicating the current status comprises information received from one or more sensor installed in the electric vehicle. In some embodiments, the information about the current status is received via a communication session opened between the computing device and a component included in the one or more electric vehicles.

At 504, the process 500 comprises identifying schedule data for the one or more vehicles. In some embodiments, the schedule data comprises information about one or more transit routes assigned to the one or more electric vehicles. In these embodiments, the information about one or more transit routes may include at least one of a distance of the one or more transit routes, locations along the one or more transit routes, or times at which the one or more transit routes are to begin or end. In the event that the information includes locations along the one or more transit routes, the locations along the one or more transit routes may be associated with times at which the one or more vehicles is scheduled to arrive at the locations.

At 506, the process 500 comprises determining a charging schedule for the one or more vehicles based on the identified schedule data. Such a charging schedule includes an order in which to direct power to the one or more charging plates. In some embodiments, the charging schedule comprises an indication of one or more periods of time over which each of the one or more vehicles is to be charged. In some embodiments, the one or more periods of time are associated with a load to be provided to the one or more vehicles. In some embodiments, the charging schedule includes instructions to replace a battery pack in the one or more vehicles.

In some embodiments, a charging schedule is determined for the fleet of electric vehicles to keep a total power load below a threshold power load capacity. In some cases, such a threshold power load capacity is static (e.g., fixed). In other cases, the threshold power load capacity is dynamically determined based on a current cost of power. For example, the threshold power load capacity may increase when the current cost of power is low and decrease when the current cost of power is high.

At 508, the process 500 comprises correlating charging plates to the one or more vehicles. In some embodiments, the charging plates are correlated to the one or more electric vehicles based on a vehicle identifier received at the one or more charging plates. For example, the vehicle identifier may be received by the charging plates from a Radio Frequency Identifier (RFID) tag included on the one or more vehicles.

At 510, the process 500 comprises directing power to one or more charging plates in accordance with the determined charging schedule. Power may be directed toward the one or more charging plates in an order specified in the charging schedule, in an amount specified in the charging schedule, and/or over a period of time specified in the charging schedule.

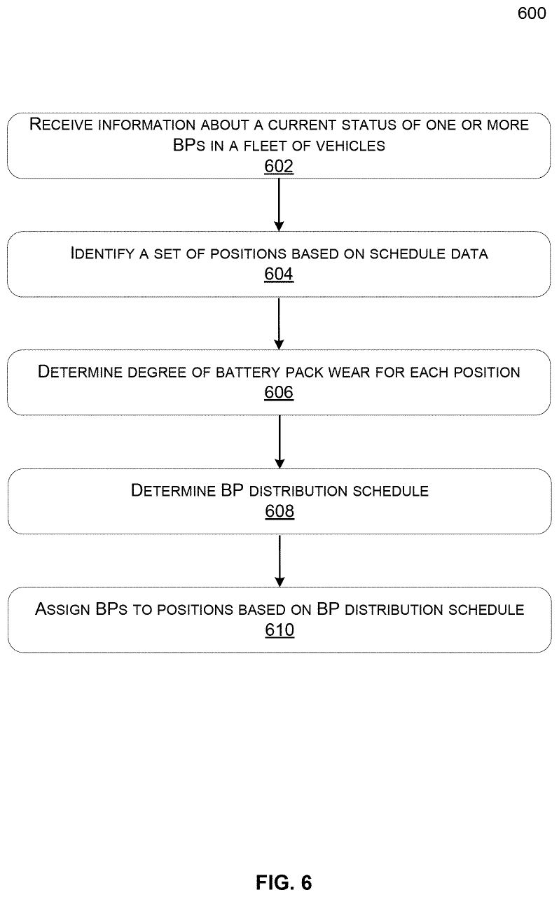

FIG. 6 depicts a flow diagram showing an example process flow 600 for distributing battery packs throughout a fleet in accordance with embodiments. The process 600 may be performed by a computing device that is configured to generate and provide a product strategy for a product. For example, the process 600 may be performed by a computing device configured to manage at least a portion of fleet operations, such as the fleet management platform 104 described with respect to FIG. 1 above.

At 602, the process 600 comprises receiving information about a current status of one or more battery packs in a fleet of vehicles. In some embodiments, the current status comprises an indication of a current battery capacity for the one or more battery packs. In some embodiments, the current battery capacity for the battery pack is determined by monitoring a change in voltage for the battery pack as the battery pack is charged or discharged. In some embodiments, the information about the current status is received via a communication session opened between the computing device and a component included in the fleet of electric vehicles. In these embodiments, information indicating the current status may comprise information received from one or more sensor installed in the electric vehicle. In some embodiments, the information indicating a current status of one or more battery packs is determined from mappings maintained by the computing device of battery packs to current wear levels.

At 604, the process 600 comprises identifying a set of positions based on schedule data for the fleet of vehicles. In some embodiments, the schedule data comprises information about one or more transit routes assigned to the one or more electric vehicles. In these embodiments, individual positions of the set of positions correspond to individual transit routes of the one or more transit routes. In some embodiments, the set of positions may comprise positions that relate to a ready-to-deploy state and positions that relate to a maintenance state.

At 606, the process 600 comprises determining a degree of battery pack wear to be associated with each of the positions in the set of positions. In some embodiments, the degree of battery pack wear is determined based on a number of recharging stations or transit stops along the respective transit route, a number of stoplights or other traffic stops along the respective transit route, or a degree of uphill incline along the respective transit route. In some embodiments, the degree of battery pack wear for a transit route of the one or more transit routes is determined based on testing performed before and after the respective transit route.

At 608, the process 600 comprises determining a battery pack distribution schedule based on the determined degree of battery pack wear associated with individual positions in the set of positions and the current status. In some embodiments, the battery pack distribution schedule comprises a correlation between the one or more battery packs and a particular position of the set of positions. In some embodiments, the set of positions comprise a set of vehicle assignments to respective transit routes. In some embodiments, the battery pack distribution schedule comprises an indication of two battery packs that are to be swapped. In some embodiments, the battery pack distribution schedule comprises a correlation of a battery pack of the one or more battery packs having the highest level of wear to a position associated with the lowest degree of battery pack wear.

At 610, the process 600 comprises assigning battery packs to positions of the set of positions based on the battery pack distribution schedule. In embodiments, in which the set of positions comprise a set of vehicle assignments to respective transit routes, assigning battery packs to positions of the set of positions may comprise installing the one or more battery pack into a vehicle assigned to a respective transit route. In embodiments, in which the battery pack distribution schedule comprises an indication of two battery packs to be swapped, assigning battery packs to positions of the set of positions comprises providing instructions to swap the two battery packs.

### Conclusion

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving information indicating a current status of one or more battery packs within a fleet of electric vehicles;
identifying a set of positions based on schedule data for the fleet of electric vehicles;
determining, for individual positions in the set of positions, a degree of battery pack wear associated with the respective position;
determining, based on the degree of battery pack wear and the current status of the one or more battery packs, a battery pack distribution schedule for the fleet of electric vehicles; and
assigning individual battery packs of the one or more battery packs to respective positions in the set of positions based on the battery pack distribution schedule.

2. The method of claim 1, wherein the current status comprises an indication of a current battery capacity for the one or more battery packs.

3. The method of claim 2, wherein the current battery capacity for the battery pack is determined by monitoring a change in voltage for the battery pack as the battery pack is charged or discharged.

4. The method of claim 1, wherein the schedule data comprises information about one or more transit routes assigned to the one or more electric vehicles and wherein individual positions of the set of positions correspond to individual transit routes of the one or more transit routes.

5. The method of claim 4, wherein the degree of battery pack wear is determined based on a number of recharging stations or transit stops along the respective transit route, a number of stoplights or other traffic stops along the respective transit route, or a degree of uphill incline along the respective transit route.

6. The method of claim 4, wherein the degree of battery pack wear for a transit route of the one or more transit routes is determined based on testing performed before and after the respective transit route.

7. The method of claim 1, wherein the set of positions comprise a set of vehicle assignments to respective transit routes.

8. The method of claim 1, wherein assigning battery packs to positions of the set of positions comprises installing the one or more battery packs into a vehicle assigned to a respective transit route.

9. The method of claim 1, wherein the set of positions comprises positions that relate to a ready-to-deploy state and positions that relate to a maintenance state.

10. A computing device comprising:
a processor; and
a memory including instructions that, when executed with the processor, cause the computing device to, at least:
receive information indicating a current status of one or more battery packs within a fleet of electric vehicles;
identify a set of positions based on schedule data for the fleet of electric vehicles;
determine, for individual positions in the set of positions, a degree of battery pack wear associated with the respective position;
determine, based on the degree of battery pack wear and the current status of the one or more battery packs, a battery pack distribution schedule for the fleet of electric vehicles; and
assign individual battery packs of the one or more battery packs to respective positions in the set of positions based on the battery pack distribution schedule.

11. The computing device of claim 10, wherein the battery pack distribution schedule comprises a correlation between the one or more battery packs and a particular position of the set of positions.

12. The computing device of claim 10, wherein the information about the current status is received via a communication session opened between the computing device and a component included in the fleet of electric vehicles.

13. The computing device of claim 12, wherein the information indicating the current status comprises information received from one or more sensor installed in the electric vehicle.

14. The computing device of claim 10, wherein the information indicating a current status of one or more battery packs is determined from mappings maintained by the computing device of battery packs to current wear levels.

15. The computing device of claim 10, wherein the battery pack distribution schedule comprises an indication of two battery packs that are to be swapped.

16. The computing device of claim 10, wherein assigning battery packs to positions of the set of positions comprises providing instructions to swap the two battery packs.

17. The computing device of claim 10, wherein the battery pack distribution schedule comprises a correlation of a battery pack of the one or more battery packs having the highest level of wear to a position associated with the lowest degree of battery pack wear.

18. A non-transitory computer-readable media collectively storing computer-executable instructions that upon execution cause one or more computing devices to collectively perform acts comprising:
receiving information indicating a current status of one or more battery packs within a fleet of electric vehicles;
identifying a set of positions based on schedule data for the fleet of electric vehicles;
determining, for individual positions in the set of positions, a degree of battery pack wear associated with the respective position;
determining, based on the degree of battery pack wear and the current status of the one or more battery packs, a battery pack distribution schedule for the fleet of electric vehicles; and
assigning individual battery packs of the one or more battery packs to respective positions in the set of positions based on the battery pack distribution schedule.

19. The non-transitory computer-readable media of claim 18, wherein the current status comprises an indication of a current battery capacity for the one or more battery packs.

20. The non-transitory computer-readable media of claim 19, wherein the information about the current status is received via a communication session opened between the computing device and a component included in the fleet of electric vehicles.
